(19) United States
(12) Patent Application Publication
(10) Pub. No.: US 2003/0005264 A1
(43) Pub. Date: Jan. 2, 2003

(54) Device and method for control of the data stream

(76) Inventors: Wolfram Drescher, Dresden (DE); Matthias Weiss, Dresden (DE)

Correspondence Address: BAKER & BOTTS, 30 ROCKEFELLER PLAZA, NEW YORK, NY, 10112

(21) Appl. No.: 10/169,229

(22) PCT Filed: Dec. 29, 2000
(86) PCT No.: PCT/DE00/04641

(30) Foreign Application Priority Data
Dec. 29, 1999 (DE) 199636133

(51) Int. Cl. G06F 9/30

(52) U.S. Cl. 712/218

(57) ABSTRACT

The invention relates to an apparatus to control data flow for a processing unit having a plurality of data paths and a plurality of parallel processing units. Each computer unit of a data path is connected to an evaluating unit, which controls the acceptance of the results into the results register by setting a flag. The output of the evaluating unit is connected to one input of a logic gate, and the other input of the logic gate to the control output of the central program control unit. The output of the logic gate is connected to the control input of the output register. In this way, each evaluating unit can check the calculation by comparing the result of computation by the parallel processing unit with a preassigned value. Upon identification of nonsense values, or upon coincidence with a preassigned value, the results register may be cleared or blocked to prevent wrong or nonsense results.

The invention relates to an apparatus to control data flow for a processing unit having a plurality of data paths, each with its register/memory, each with its corresponding processing unit and a results register, each of the processing units operating according to the same algorithm and each containing a computing unit, and each data path as well as each results register being connected to the control output of a central program control unit.

It is known that the requirements for processing speed of digital signal processors have increased steadily of recent years. To satisfy these requirements, chiefly two approaches have been taken. In one, it has been attempted to design new computers that operate at a higher timing frequency. For this, firstly the advances in semiconductor technology have been utilized, permitting smaller transistor sizes, and secondly the critical paths in the computers have been shortened by “pipelining” [M. Nomurh et al., “A 300 Mhz 16-b 0.5 μm BiCMOS Digital Signal Processor Core LSI,” IEEE Journal of Solid State Circuits, Vol. 29, No. 3, March 1994, pages 290-297]; [J. Goto et al., “250-Mhz BiCMOS Super-High-Speed Video Signal Processor (S-VSP) ULSI,” IEEE Journal of Solid State Circuits, Vol. 26, No. 12, December 1991, pages 1876-1884]. Secondly, there are approaches combining several computing units with each other in such manner that they operate in parallel [J. Kneip, M. Berekovic, J. P. Wittenberg, W. Hinrichs and P. Pirsch, “An Algorithm Adapted Autonomous Controlling Concept for a Parallel Single-Chip Digital Signal Processor,” Journal of VLSI Signal Processing 16, Kluwer Academic Publishers, pages 31-40, 1997]; [M. Toyokura et al., “A Video DSP with a Macroblock-Level Pipeline and a SIMD Type Vector Pipeline Architecture for MPEG-2 CODEC,” IEEE Journal of Solid State Circuits, vol. 29, no. 12, December 1994, pages 1474-1481]. By the distribution over several units, the speed of the system as a whole is to be increased.

The first approach is problematical for the reason that high-rhythm computers exhibit a high power take-up. In particular for service in mobile units, systems containing such computers are of limited suitability. The combination of several lower-rhythm computers is less problematical from this aspect. Furthermore, this approach is always dependent on the available technology, whereas the combination of parallel-operating processing units makes possible an almost arbitrary sizing of the system power, and hence the total power of the system can be uncoupled from the timing frequency.

For parallel systems, generally two approaches can be distinguished. On the one hand, there is the “multiple-instruction multiple-data” (MIMD) approach. This means that in a system of parallel-operating processing units, each of these processing units at a certain time can execute a different machine command than all the others can execute. Besides, each of the processing units can compute with different data.

On the other hand, there is the “single-instruction multiple-data” (SIMD) approach, which means that while all processing units process different data, they each do so in the same mode and manner. Hence only one machine command is needed to control all the processing units. The SIMD approach is favored primarily by the fact that it permits the building of very small and simple systems of parallel computing units. This is because here only one central program control unit is required to control the processing units. By contrast, each processing unit in the MIMD approach requires its own decoder. In systems of any size, this leads to higher power uptake. On the other hand, the MIMD approach offers more effective utilization of the processing units for certain applications. Beyond the pure SIMD and MIMD approaches, there are also combined systems in which the advantages and disadvantages of the two methods can be balanced against each other.

In other publications ([1] J. Kneip, M. Berekovic, J. P. Wittenberg, W. Hinrichs and P. Pirsch, “An Algorithm Adapted Autonomous Controlling Concept for a Parallel Single-Chip Digital Signal Processor,” Journal of VLSI Signal Processing 16, Kluwer Academic Publishers, pages 31-40, 1997; [2] W. Gehrke and K. Gaedke, “Associative Controlling of Monolithic Parallel Processor Architectures,” IEEE Transactions on Circuits and Systems for Video Technology, Vol. 5, No. 5, pages 453-464, October 1995; [3] W. Gehrke and K. Gaedke, DE 195 32 527 A1, Letters of Disclosure, German Patent Office 1997; [5] M. Toyokura et al., “A Video DSP with a Macroblock-Level Pipeline and a SIMD Type Vector Pipeline Architecture for MPEG-2 CODEC,” IEEE Journal of Solid State Circuits, Vol. 29, No. 12, December 1994, pages 1474-1481; [8] C. J. Zarowski, “Parallel Implementation of the Schur-Berlekamp-Massey Algorithm on a Linearly Connected Processor Array,” IEEE Transactions on Computers, Vol. 44, No. 7, July 1995), similar structures have been proposed. These structures deal with the control of program flow. In [3], it is set forth in detail what is to be controlled (loops, subprograms, distributors). The approach there pursued functions in that to each of the processing units, several machine commands are delivered, while ultimately, depending on certain control signals, only one machine command is executed.

Control of program flow for many applications with parallel processors, particularly in digital signal processing, however, is only of subordinate importance. More important, rather, is the control of data flow. The approach here described is distinguished primarily by the control object. One possibility for control of data flow in a special hardware apparatus is described in [8]. This apparatus, however, is not part of a programmable processor.

An example of the need for effective data flow control, particularly for parallel processors for digital signal processing, is the Berlekamp-Massey algorithm. There, in each loop passage, the same operations are performed, only with different operands. Effective control of the operand selection (of the data flow) is therefore of paramount importance. A similar algorithm from this aspect is the Viterbi algorithm, in which, in each iteration, two or more sums are formed, one of them, on the basis of a comparison decision, providing the input value for the next iteration. Here again, the operation to be performed is always the same, but an operand selection (data flow control) must be made.

The object of the invention is to create an apparatus and a process to control data flow for a processing unit having a plurality of parallel data paths, by means of which it is possible to control the function of the processing units, i.e. acceptance of the result of computation into the corresponding results register, directly by way of the data flow.

The object to which the invention is addressed, in an apparatus of the kind initially mentioned, is accomplished in that each computing unit of a data path is connected to an evaluating unit that controls the acceptance of the result of computation by the computing unit into the proper results register by setting a flag or by a simple IF query.

In an advantageous modification of the invention, the output of the evaluating unit is connected to one input of a logic gate, and the other input of the logic gate to the control output of the central program control unit, and the output of the logic gate to the control input of the results register. The logic gate may for example be an AND gate. An OR gate may also be employed without problems in this place.

Thus, in simple manner, it becomes possible to ascertain whether the control signal of the central program control unit triggers a write operation in the results register, or clears the result of computation by the computer unit as written in the results register.

The object to which the invention is addressed is further accomplished by a method of data flow control in that each evaluating unit checks the result of computation by the processing unit of the particular data path for plausibility, by comparing the result of computation with a preassigned value, and clears the results register upon identifying nonsense values or coincidence with a preassigned value.

A special variant of the process is characterized in that the evaluating unit checks the result of computation by the current data path for plausibility by comparing the result of computation with a preassigned value, and upon identification of nonsense values or upon coincidence with a preassigned value, blocks acceptance of the result of computation into the results register.

By virtue of the invention, it becomes possible, without intervention by the central control unit, that is, without additional software outlay, to bring it about that individual results of computation from individual data paths can be excluded from further processing if the result of computation by the computer yields a nonsense result. The data flow is thus controlled by the result of computation by the processing unit itself.

This results check, implemented hardware-wise in each data path, can be accomplished simply by an IF query or by setting a “flag.” That is, there is no program control here, only data flow control.

The invention will now be illustrated in more detail in terms of an embodiment by way of example. In the accompanying drawings,

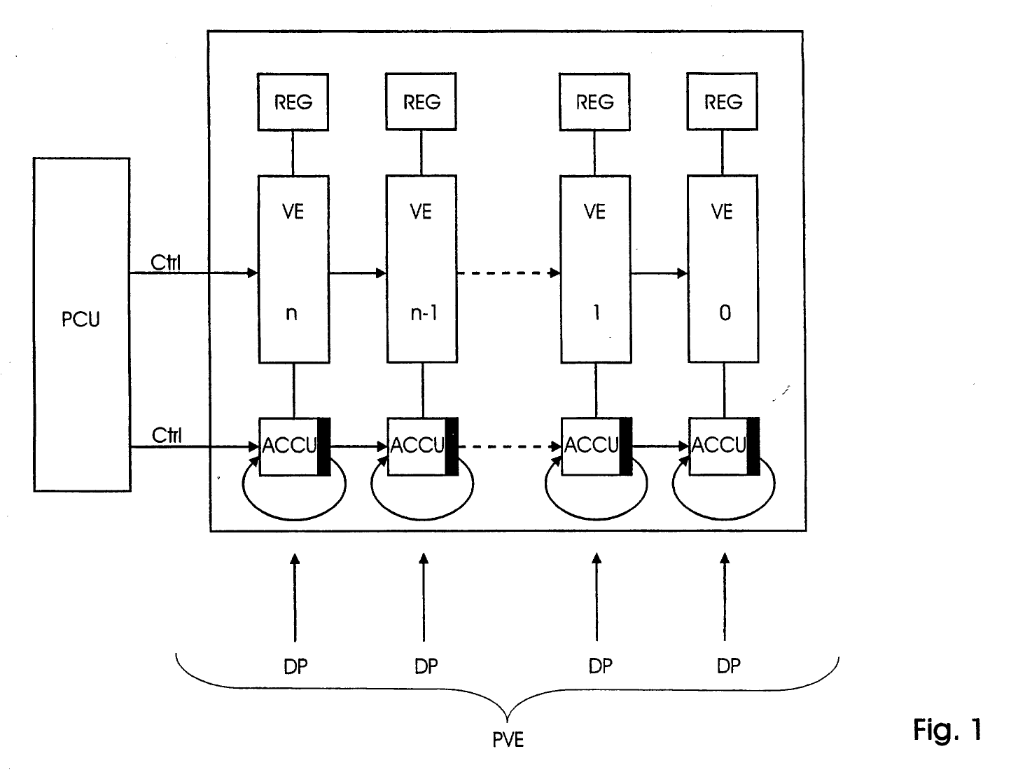

FIG. 1 shows a conventional circuit apparatus for a “single instruction data control” unit; and,

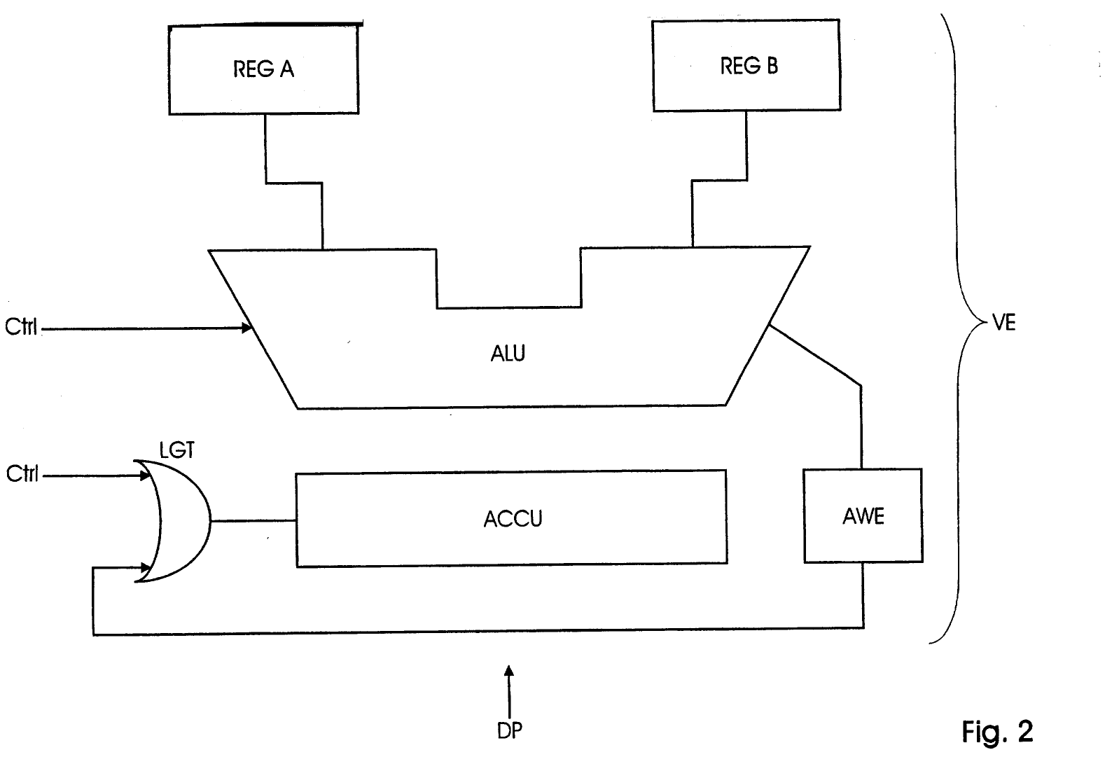

FIG. 2 shows a circuit apparatus according to the invention to control data flow for a data path.

To clarify the starting condition, FIG. 1 shows a circuit diagram of a conventional SIMD signal process. This SIMD unit consists of a processing unit PVE having a plurality of parallel processing units VE each forming a data path DP. Each of these parallel processing units VE contains a computer ALU (“Arithmetic Logic Unit”) preceded by a register REG, whose result of calculation is written into a results register/memory ACCU.

The parallel processing units are controlled by a central program control unit PCU, in which all parallel processing units VE are controlled with the same machine command Crtl. In like manner, the writing into the results register/memory ACCU of the current parallel processing units is controlled by the same machine command Crtl. Thus, all parallel processing units VE can process different data according to the same algorithm.

This SIMD signal processing is enlarged by the invention into an apparatus for control of data flow. The diagram of a corresponding circuit arrangement may be seen in FIG. 2.

Each computer unit ALU of a data path DP is connected to an evaluating unit AWE, which controls the acceptance of the computer ALU's result into the results register ACCU by setting a flag.

The output of the evaluating unit AWE is connected for this purpose to one input of a logic gate LGT, and the other input of the logic gate LGT to the control output of the central program control unit PCU. The output of the logic gate LGT, which may be an AND or alternatively an OR gate, is connected to the control input of the results/memory ACCU.

In this way, each evaluating unit AWE can check the result of computation by the parallel processing unit VE of the current data path DP for plausibility, in that the result of computation by the parallel processing unit VE is compared with a preassigned value. Upon identification of nonsense values, or upon coincidence with a preassigned value, the results register ACCU is cleared.

In a special variant, the evaluating unit AWE checks the result of computation by the computer ALU of the parallel processing unit VE of the current data path DP for plausibility. This may be done simply in that the result of computation of the parallel processing unit VE is compared with a preassigned value. Upon identification of nonsense values, or upon coincidence with a preassigned value, acceptance of the result of computation by the parallel processing unit VE into the results register ACCU is blocked.

The invention prevents wrong or nonsense results of computation from being written into the results register ACCU of the corresponding data path DP. That is, the data path DP is barred for one cycle in event of a nonsense result.

The advantage of data flow control over program flow control lies in that only a single instruction need be forwarded to all processing units VE of like kind. Here, however, the instruction must contain information about the alternative data sources. Such data sources may be either busses or else registers. By the forwarding of a single instruction to each parallel processing unit VE, wiring outlay and consequently area are saved on the chip.

Another advantage lies in the fact that a central program control PCU to control the program flow at each point in time to the like parallel processing units VE need issue only one word of command, and may therefore be of simpler structure.

This in turn leads to a saving of chip area. Therefore, costs of production are reduced and so is the power uptake of the chip.

### List of References

| | |
|---|---|
| DP | data path |
| PVE | parallel processing unit |
| REG | register |
| ACCU | results register |
| VE | processing unit |
| PCU | central program control |
| ALU | computer (“Arithmetic Logic Unit”) |
| LGT | logic gate |
| AWE | evaluating unit |

1. Apparatus to control data flow for a processing unit (PVE) having a plurality of parallel data paths (DP) each with its register/memory (REG), each with its corresponding processing unit (VE) and a results register (ACCU), the processing units (VE) operating according to the same algorithm and each containing a computing unit (ALU) and each data path (DP) as well as each results register (ACCU) being connected to the control output of a central program control unit (PCU), characterized in that each computing unit (ALU) of a data path (DP) is connected to an evaluating unit (AWE) that controls acceptance of the result of computation by the computing unit (ALU) into the corresponding results register (ACCU) by setting a flag or by an IF inquiry.

2. Apparatus according to claim 1, characterized in that the output of the evaluating unit (AWE) is connected to one input of a logic gate (LGT) and the other input of the logic gate (LGT) to the control output of the central program control unit (PCU), as well as the output of the logic gate (LGT) to the control input of the results register (ACCU).

3. Apparatus according to claim 2, characterized in that the logic gate (LGT) is an AND gate.

4. Process for control of data flow in an apparatus according to any of claims 1 to 3, characterized in that each evaluating unit (AWE) checks the result of computation by the processing unit (VE) of the current data path (DP) for plausibility, in that the result of computation is compared with a preassigned value, and upon identification of nonsense values or coincidence with a preassigned value, clears the results register (ACCU).

5. Process to control data flow in an apparatus according to any of claims 1 to 3, characterized in that the evaluating unit (AWE) checks the result of computation by the processing unit (VE) of the current data path (DP) for plausibility, in that the result of computation is compared with a preassigned value, and upon identification of nonsense values or upon coincidence with a preassigned value, acceptance of the result of computation into the results register (ACCU) is blocked.
